(19) United States
(12) Patent Application Publication
(10) Pub. No.: US 2016/0138417 A1
(43) Pub. Date: May 19, 2016

(54) TURBINE AND METHOD FOR DETECTING RUBBING

(71) Applicant: SIEMENS AKTIENGESELLSCHAFT, München (DE)

(72) Inventors: Alexander Seroka, Bochum (DE); Raoul Costamagna, Mulheim an der Ruhr (DE); Uwe Sieber, Mulheim an der Ruhr (DE)

(73) Assignee: Siemens Aktiengesellschaft, Munich (DE)

(21) Appl. No.: 14/900,164

(22) PCT Filed: Jun. 18, 2014
(86) PCT No.: PCT/EP2014/062787

§ 371 Date: Dec. 20, 2015

(30) Foreign Application Priority Data
Jun. 26, 2013 (DE) 10 2013 212 252.7

(51) Int. Cl. F01D 21/00; F01D 25/24; F01D 5/02

(52) U.S. Cl. CPC F01D 21/003; F01D 5/02; F01D 25/24; F05D 2220/32; F05D 2240/24; F05D 2260/83

(57) ABSTRACT

A turbine, in particular a gas turbine, includes a rotor, a housing spaced from the rotor by a gap, and a system for monitoring structure-borne noise, permit rubbing of the rotor and the housing to be localised with the least possible technical complexity. In both a first and second axial region, one or more inwardly directed rubbing teeth of the housing and one or more outwardly directed rubbing edges of the rotor are arranged, wherein the one or more rubbing teeth and the one or more rubbing edges are distributed along the circumference such that contact of the particular rubbing teeth and rubbing edges at a specified rotational frequency of the rotor occurs at a different frequency in the first axial region than in the second axial region.

### CROSS REFERENCE TO RELATED APPLICATIONS

This application is the U.S. National Stage of International Application No. PCT/EP2014/062787 filed Jun. 18, 2014, and claims the benefit thereof. The International Application claims the benefit of German Application No. DE 102013212252.7 filed Jun. 26, 2013. All of the applications are incorporated by reference herein in their entirety.

### FIELD OF INVENTION

The invention relates to a turbine, in particular a gas turbine, comprising a rotor, a housing spaced apart from the rotor by a gap, and a system for monitoring structure-borne noise. It further relates to a method for detecting rubbing in a turbine, in particular a gas turbine, comprising a rotor, a housing spaced apart from the rotor by a gap, and a system for monitoring structure-borne noise.

### BACKGROUND OF INVENTION

A turbine is a fluid-flow machine which converts the internal energy (enthalpy) of a flowing fluid (liquid or gas) into rotational energy and ultimately into mechanical drive energy. Part of the internal energy is extracted from the fluid stream by the flow around the turbine blades, which is as eddy-free and laminar as possible, said energy being transferred to the rotor blades of the turbine. The turbine shaft is then set rotating by the latter; the usable power is output to a coupled working machine, such as a generator. Rotor blades and shaft are parts of the movable rotor of the turbine, which is arranged within a housing.

As a rule, a plurality of blades are mounted on the shaft. Rotor blades mounted in one plane respectively form a blade wheel or an impeller. The blades are profiled so as to be slightly curved, similarly to an aerofoil. There is usually a guide wheel before each impeller. These guide vanes project from the housing into the flowing medium and set the latter spinning. The spin generated in the guide wheel (kinetic energy) is used in the following impeller to set the shaft on which the impeller blades are mounted rotating.

Guide wheel and impeller are together designated a stage. Often, a plurality of such stages are connected one after another. Since the guide wheel is stationary, the guide vanes thereof can be fixed both to the interior of the housing and to the exterior of the housing, and thus offer a bearing for the shaft of the impeller.

Between the guide vane ends of the rotor and the housing there is usually a gap which, for example, is used to compensate for the thermal expansion during operation. In order to achieve a high efficiency, the gap between blade end and housing should be a minimum, however, since fluid flows past the rotor blades through the gap and thus does not contribute to the production of energy.

As a result of the conical shape of the turbine and the housing surrounding the latter, it is possible to influence the gap size by a displacement of the rotor with respect to the housing by means of an appropriate setting device. In practice, a displacement of the rotor only by a fixed, predefined length, e.g. 2.4 or 3.0 mm, typically takes place. It is also known to use systems for monitoring structure-borne noise in order to detect rubbing of the turbine dynamically by means of the detection of the vibrations produced by the rotor rubbing on the housing, and to optimize the gap in this way by proceeding further. Such a system is known, for example from GB 2 396 438 A.

However, the systems known hitherto permit only basic detection of rubbing. For further gap optimization, however, for example including shortly after starting the plant, when the turbine has not yet warmed up completely, it would be desirable to be able to localize the rubbing as exactly as possible.

### SUMMARY OF INVENTION

It is therefore an object of the invention to indicate a turbine and a method of the type mentioned at the beginning which permit localization of rubbing of rotor and housing with the least possible technical outlay.

With respect to the turbine, the object is achieved, according to the invention, in that, in both a first and second axial region, there are arranged one or more inwardly directed rubbing teeth of the housing and one or more outwardly directed rubbing edges of the rotor, and wherein the one or more rubbing teeth and the one or more rubbing edges are distributed along the circumference in such a way that contact of the respective rubbing teeth and rubbing edges at a specified rotational frequency of the rotor occurs at a different frequency in the first axial region than in the second axial region.

With respect to the method, the object is achieved in that, in a turbine configured according to the preceding paragraph, by means of the system for monitoring structure-borne noise, when a limiting amplitude of a first frequency derived from the rotational frequency of the rotor is exceeded, contact in a first axial region is detected and, when a second frequency derived from the rotational frequency of the rotor and different from the first frequency is exceeded, with the same rotational frequency of the rotor, contact in a second axial region is detected.

The invention is based on the thought that technically particular localization of the rubbing would be achievable if this were possible merely by means of the system for monitoring structure-borne noise, without additional sensors being necessary. For this purpose, rubbing events at different locations would have to be distinguishable by using the structure-borne vibrations produced thereby, so that a specific structure-borne noise signal can be assigned to a specific location. Here, a parameter that is easily distinguishable is the frequency of the signal. This depends on the current rotational frequency but can be modified by appropriate rubbing edges being positioned on the rotor and appropriate rubbing teeth being positioned on the housing. Depending on the configuration of the edges and teeth, the result is thus that they generate different frequencies in different axial regions, rubbing can be localized in the axial direction.

In an advantageous refinement of the turbine, in the first and in the second region, a different number of rubbing edges is arranged uniformly along the circumference of the rotor. This is because, with regard to the method, a uniformly distributed number of rubbing edges advantageously results in a structure-borne vibration at a frequency which is an integer multiple of the rotational frequency. If, for example, three rubbing edges are positioned in a first axial region and four rubbing edges are positioned in a second axial region on the rotor, a signal with three times or, respectively, four times the frequency of the rotational frequency is generated in the respective region in the event of rubbing. The two signals are therefore particularly easily distinguishable and rubbing can be localized with regard to the axial position.

In a further advantageous refinement of the turbine, the rubbing teeth are distributed along the circumference of the housing in such a way that different spacings result between adjacent rubbing teeth in the circumferential direction. If the teeth are sufficiently closely positioned such that rubbing occurs on two teeth, two vibrations with the same frequency are produced, the phase difference being correlated with the spacing of the teeth. With regard to the method, a position of the contact in the circumferential defection is then advantageously determined by using a phase shift of two superimposed signals.

In a particularly simple advantageous refinement, adjacent rubbing teeth in the circumferential direction have a spacing from one another that rises linearly in the circumferential direction. As a result, with regard to the method, the magnitude of the phase shift is advantageously linked linearly with the angular position of the contact. This permits particularly simple localization of the rubbing in the circumferential direction.

In an alternative or additional refinement of the turbine, the system for monitoring structure-borne noise has a multiplicity of vibration sensors distributed along the circumference. With regard to the method, the position of the contact in the circumferential direction can advantageously be determined as a result by using the amplitude relationships of the signals from the vibration sensors distributed along the circumference. The localization of the contact can therefore also be carried out in the sense of echo location, since the amplitude is the greatest on the vibration sensor which is closest to the rubbing location.

In an advantageous refinement of the turbine, the gap between rotor and housing can be set by means of a setting device, in particular by displacing rotor and housing toward each other, and the setting device is connected on the input side to the system for monitoring structure-borne noise. Advantageously, in a method for minimizing the gap by means of the method described for rubbing detection, a minimum gap (d) is set. Here, the rotor is displaced until there is just no longer any contact generating any output signals. This means that the rotor is displaced until the turbine rotor blades come into contact with the housing. This contact is monitored by means of a system for monitoring structure-borne noise and, in this way, the travel is restricted. As soon as a first contact indication is registered, the rotor, if appropriate following a short reverse displacement, is fixed just at the limit relating to the contact. The direction of the displacement can be optimized on account of the exact localization of the rubbing.

A power plant advantageously comprises a turbine described.

The advantages achieved by the invention consist in particular in the fact that, as a result of the exactly localizable detection of contact between rotor and housing, still further optimized minimization of the gaps between rotor and housing is made possible by technically particularly simple means. Rubbing can be detected at many locations both in the axial and in the circumferential direction during the operation of the turbine without internal instrumentation and with few measuring sensors. In addition, already existing turbines can be retrofitted with appropriate rubbing edges and teeth.

The efficiency of the turbine is maximized as a result and the output is increased. This also offers advantages with regard to environmental compatibility since, by means of a process control change, a considerable saving in fuel and emissions is achieved.

### BRIEF DESCRIPTION OF THE DRAWINGS

An exemplary embodiment of the invention will be explained in more detail by using a drawing, in which:

FIG. 1 shows a partial longitudinal section through a gas turbine.

FIG. 2 shows, schematically, a cross section through a first radial region of the gas turbine, and

FIG. 3 shows, schematically, a cross section through a second radial region of the gas turbine.

### DETAILED DESCRIPTION OF INVENTION

The same parts are provided with the same designations in all the figures.

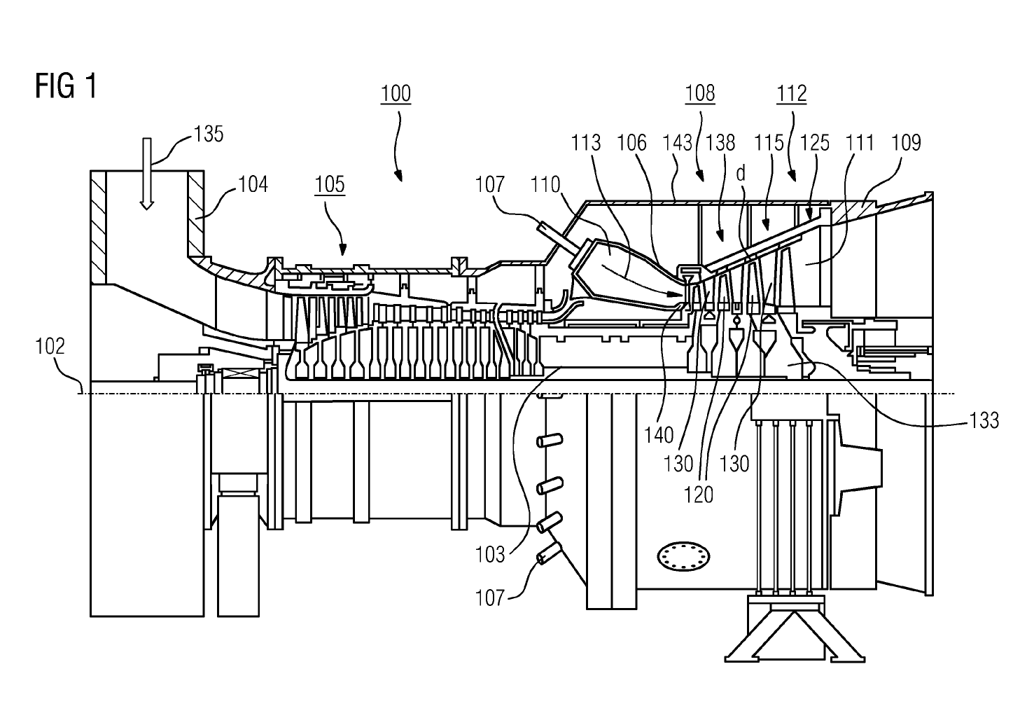

FIG. 1 shows a turbine 100, here a gas turbine, in a partial longitudinal section. The gas turbine 100 has in the interior a rotor 103, which is also designated a turbine rotor, mounted such that it can rotate about an axis of rotation 102 (axial direction). Along the rotor 103, an intake housing 104, a compressor 105, a toroidal combustion chamber 110, in particular an annular combustion chamber 106, having a plurality of burners 107 arranged coaxially, a turbine 108 and the exhaust gas housing 109 follow one another.

The annular combustion chamber 106 communicates with an annular hot gas channel 111. There, for example, four turbine stages 112 connected one behind another form the turbine 108. Each turbine stage 112 is formed from two rings of blades. As seen in the flow direction of a working medium 113, a row 125 formed from rotor blades 120 follows in the hot gas channel 111 of a row 115 of guide vanes.

The guide vanes 130 are fixed to the stator 143, whereas the rotor blades 120 of a row 125 are attached to the rotor 103 by means of a turbine disk 133. The rotor blades 120 thus form constituent parts of the rotor 103. A generator or a working machine (not illustrated) is coupled to the rotor 103.

During the operation of the gas turbine 100, air 135 is taken in through the intake housing 104 by the compressor 105 and is compressed. The compressed air made available at the turbine-side end of the compressor 105 is led to the burners 107 and is mixed with a fuel there. The mixture is then burned in the combustion chamber 110, forming the working medium 113. From said chamber, the working medium 113 flows along the hot gas channel 111 past the guide vanes 130 and the rotor blades 120. At the rotor blades 120, the working medium 113 expands, transferring momentum, so that the rotor blades 120 drive the rotor 103 and the latter drives the working machine coupled thereto.

The components exposed to the hot working medium 113 are subject to thermal stresses during the operation of the gas turbine 100. The guide vanes 130 and rotor blades 120 of the first turbine stage 112, seen in the flow direction of the working medium 113, are thermally stressed most, apart from the heat-shield refractories lining the annular combustion chamber 106. In order to withstand the temperatures prevailing there, these are cooled by means of a coolant. Likewise, the blades and vanes 120, 130 can have coatings against corrosion (MCrAlX; M=Fe, Co, Ni, rare earths) and heat (thermal insulating layer, for example ZrO2, Y2O4—ZrO2).

The guide vane 130 has a guide vane foot (not illustrated here) facing the inner housing 138 of the turbine 108, and a guide vane head opposite the guide vane foot. The guide vane head faces the rotor 103 and is fixed to a fixing ring 140 of the stator 143.

On the guide side, the gas turbine 100 according to the figure has a system for monitoring structure-borne noise, not specifically illustrated, which is connected to a multiplicity of sensors on the rotor 103 and housing 138, which acquire output signals with respect to the noise vibrations arising in the turbine 100.

Furthermore, the rotor 103 can be displaced axially along the shaft 102. Because of the conicity of the rotor tips of the rotor 103 and of the housing 138 in relation to each other, as a result of an axial displacement of the rotor 103 or of the housing 138, the gap d between rotor 103, in particular the rotor blade ends, and housing 138 is reduced or enlarged. The axial displacement is carried out hydraulically.

By means of an axial displacement of the rotor 103 with respect to the housing 138, the existing gap d is narrowed, and until ultimately a first contact is produced, which leads to vibrations and therefore to the production of noise. This noise is transmitted through the housing 138 and is detected by the system for monitoring structure-borne noise and converted into corresponding output signals.

Depending on the axial displacement of the rotor blades 120 with respect to the housing 138, more or less intense contact between the turbine blades 120 and the housing 138 is produced, which means that the intensity of the structure-borne noise produced and therefore of the output signals also changes.

Different output signals thus result, depending on the value of the axial displacement.

If a first contact has been produced, the rotor blades 120 are fixed or else—in the event of not too intense a contact—are displaced back again until there is just no longer any contact indicated by a corresponding output signal. A minimum gap d has then been set. This setting of the minimum gap can be carried out during operation, typically after the turbine 100 has warmed up completely.

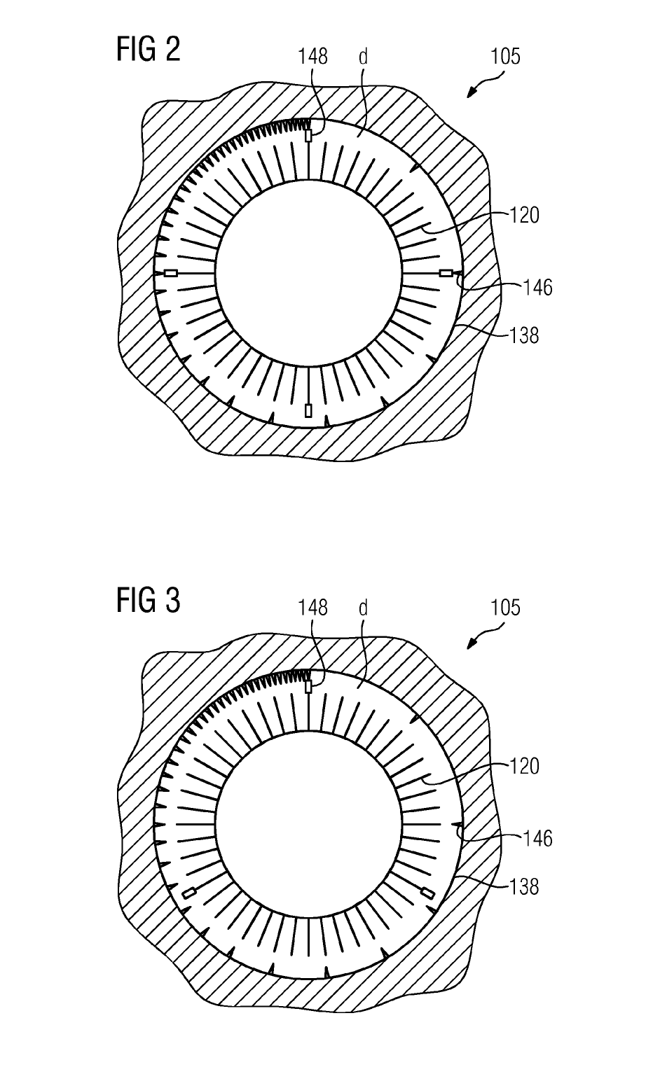

In order to be able to exactly localize the rubbing described and to permit more accurate regulation of the gap d, the turbine 100 is equipped with corresponding structural measures, which are explained in the following FIGS. 2 and 3.

FIGS. 2 and 3 show a cross section through two radial regions of the compressor 105, more exactly each through a circle of rotor blades 120 with the surrounding housing 138. Arranged on the inner side of the housing 138, along the circumference, are rubbing teeth 146 which project radially inward. Rubbing edges 148 are arranged on the radial outer end of some rotor blades 120.

In the region shown in FIG. 2, four rubbing edges 148 are arranged at a uniform spacing along the circumferential direction, i.e. with an angular spacing of respectively ninety degrees. In the region shown in FIG. 3, three rubbing edges 148 are arranged at a uniform spacing along the circumferential direction, i.e. with an angular spacing of respectively one hundred and twenty degrees. In the event of contact between rubbing edges 148 and rubbing teeth 146 in the first region, a structure-borne noise signal with a frequency which corresponds to four times the current rotational frequency of the rotor 103 is thus produced, while in the event of contact between rubbing edges 148 and rubbing teeth 146 in the second region, a structure-borne noise signal with a frequency which corresponds to three times the current rotational frequency of the rotor 103 is produced. In an analogous way, rubbing edges 148 with different spacings are distributed in further regions of the compressor. By means of analyzing the frequency of the structure-borne noise, the rubbing can thus be localized axially.

The rubbing teeth 146 on the housing 138 in FIGS. 2 and 3 are distributed in the circumferential direction with a spacing rising linearly from the uppermost point. This also permits localization of the rubbing in the circumferential direction since, in the event of rubbing on two rubbing teeth 146, two structure-borne noise signals of the same frequency are generated but their phase shift is different, depending on the spacing of the rubbing teeth 146. Since each spacing between adjacent rubbing teeth 146 is different, conclusions about the circumferential position of the rubbing can be drawn from the magnitude of the phase shift.

Appropriate structural measures are provided in the turbine 108. The rubbing edges and teeth 146, 148 have an outer wearing layer. The outer wearing layer is, for example, porous and/or ceramic, so that a slight contact also causes no permanent damage.

The evaluation method in the system for monitoring structure-borne noise is designed for an appropriate analysis of the signal; it is able to resolve frequencies and phase shifts. The data relating to the structural arrangement of the rubbing edges and teeth 146, 148 is stored in the system for monitoring structure-borne noise. Likewise, the system for monitoring structure-borne noise has access on the input side to the current rotational speed of the rotor 103.

In an alternative embodiment, not shown, the system for monitoring structure-borne noise is configured for echo location, i.e. a plurality of noise sensors are distributed along the circumference. By means of an analysis of the magnitude of the amplitudes from the noise sensors, the system for monitoring structure-borne noise is able to determine the relative proximity of the rubbing event to the respective noise sensor and to perform localization in an echo-location manner.

1.-14. (canceled)

15. A turbine, comprising
a rotor, a housing spaced apart from the rotor by a gap, and a system for monitoring structure-borne noise,
wherein, in both a first and second axial region, the housing comprises one or more inwardly directed rubbing teeth and the rotor comprises one or more outwardly directed rubbing edges,
wherein the one or more rubbing teeth and the one or more rubbing edges are distributed along the circumference such that contact of the respective rubbing teeth and rubbing edges at a specified rotational frequency of the rotor occurs at a different frequency in the first axial region than in the second axial region.

16. The turbine as claimed in claim 15,
wherein, in the first and in the second region, a different number of rubbing edges is arranged uniformly along the circumference of the rotor.

17. The turbine as claimed in claim 15,
wherein the rubbing teeth are distributed along the circumference of the housing such that different spacings result between adjacent rubbing teeth in the circumferential direction.

18. The turbine as claimed in claim 17,
wherein adjacent rubbing teeth in the circumferential direction have a spacing from one another that rises linearly in the circumferential direction.

19. The turbine as claimed in claim 15,
wherein the system for monitoring structure-borne noise comprises a multiplicity of vibration sensors distributed along the circumference.

20. The turbine as claimed in claim 15, further comprising:
a setting device for setting the gap between rotor and housing by displacing the rotor and housing toward each other,
wherein the setting device is connected on the input side to the system for monitoring structure-borne noise.

21. A method for detecting rubbing in a turbine as claimed in claim 15, the method comprising:
detecting contact in a first axial region by the system for monitoring structure-borne noise, when a limiting amplitude of a first frequency derived from the rotational frequency of the rotor is exceeded, and
detecting contact in a second axial region when a second frequency derived from the rotational frequency of the rotor and different from the first frequency is exceeded, with the same rotational frequency of the rotor.

22. The method as claimed in claim 21,
wherein the frequency is an integer multiple of the rotational frequency.

23. The method as claimed in claim 21, further comprising:
determining a position of the contact in the circumferential direction by using a phase shift of two superimposed signals of the same frequency.

24. The method as claimed in claim 23, further comprising:
linking a magnitude of the phase shift linearly with the angular position of the contact.

25. The method as claimed in claim 21, further comprising:
determining a position of the contact in the circumferential direction by using amplitude relationships of the signals from a multiplicity of vibration sensors distributed along the circumference.

26. A method for minimizing a gap in a turbine as claimed in claim 15, the method comprising:
setting the gap by displacing the rotor and the housing toward each other,
wherein a minimum gap is set by:
detecting contact in a first axial region by the system for monitoring structure-borne noise, when a limiting amplitude of a first frequency derived from the rotational frequency of the rotor is exceeded, and
detecting contact in a second axial region when a second frequency derived from the rotational frequency of the rotor and different from the first frequency is exceeded, with the same rotational frequency of the rotor.

27. A power plant having a turbine as claimed in claim 15.

28. The turbine as claimed in claim 15,
wherein the turbine comprises a gas turbine.

29. The method as claimed in claim 21,
wherein the turbine comprises a gas turbine.
